(19) United States
(12) Patent Application Publication
(10) Pub. No.: US 2013/0247839 A1
(43) Pub. Date: Sep. 26, 2013

(54) Lungie pet leash

(71) Applicant: Scott Clair Pockrandt, Ridgecrest, CA (US)

(72) Inventor: Scott Clair Pockrandt, Ridgecrest, CA (US)

(21) Appl. No.: 13/694,432

(22) Filed: Dec. 3, 2012

Related U.S. Application Data
(60) Provisional application No. 61/630,319, filed on Dec. 9, 2011.

(51) Int. Cl. A01K 27/00

(52) U.S. Cl. CPC A01K 27/003
USPC 119/798

(57) ABSTRACT

The Liquid Nitrogen Cooling System utilizes a continuously recharged, closed-loop system to: generate electricity; charge and pressurize hydraulic bypass and operational equipment; and, provide emergency cooling.

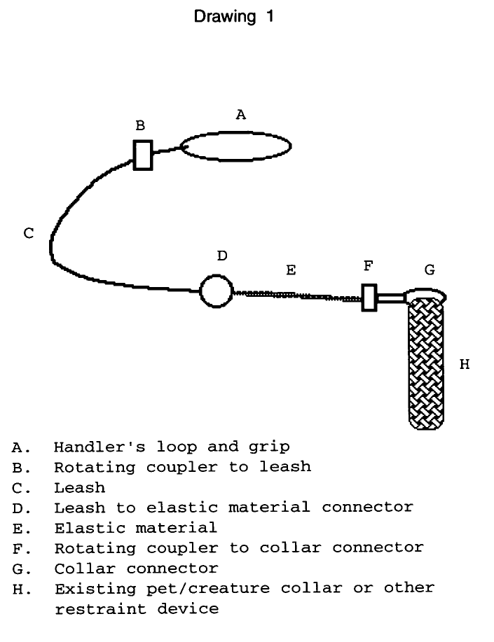

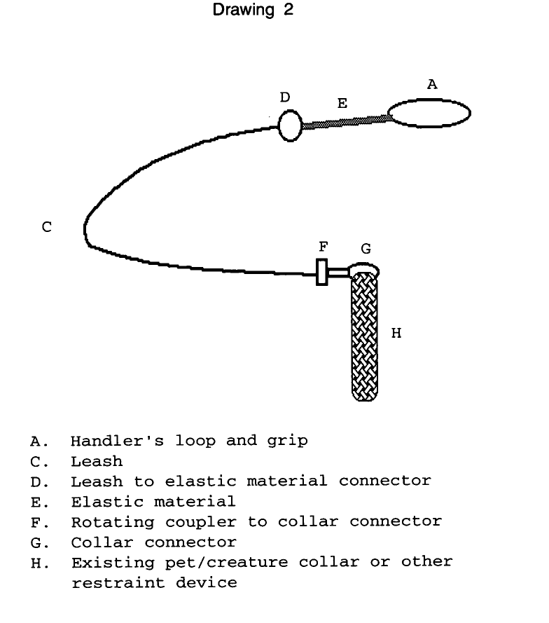

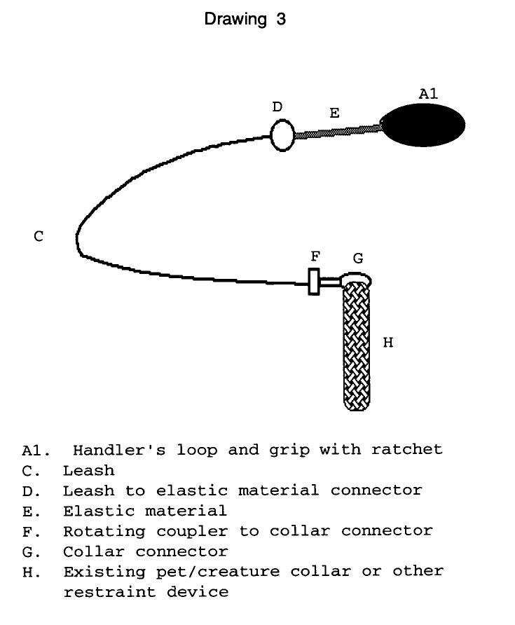

It is triggered by any need for emergency shutdown, applying liquid Nitrogen to cool a nuclear power plant, as an alternate cooling system independently from the regular cooling system, providing a sudden drop of temperature through a liquid Nitrogen manifold system.

No greenhouse or explosive gases are generated or released, and no Oxygen is used. Any Nitrogen vented to the atmosphere dissipates rapidly, assumes ambient temperature, and has no long half-life radioactive isotopes. It operates as a closed/static system until needed for cooling.

Applications include, but are not limited to, retrofitting to existing systems.

Current leashes and collars operate to restrain and/or control the movements of pets, and their behavior. Each of the existing designs causes vibration, movement and sudden changes in direction to be transmitted both from the handler and the pet to the other in sharp and sudden manner.

My device, as described in the accompanying drawings and explanatory materials, reduces the impact and sudden nature of the vibration, movements and changes in direction, without interfering with the control of the pet. This increases effective control of the pet, while protecting the handler from potentially severe injury, including hyper extension of elbows, and dislocation of shoulders.

The application of this process and method, is not a “common usage” or “obvious” use or combination of the materials involved. There is no other system which takes advantage of the inherent pressures within a system in the way presented here.

With sizes made properly for individual pets and/or their weights, the device is appropriate for a wide range of pets, including dogs, cats and larger and more exotic creatures.

### Basic Operating Parameters

The elastic material acts as a shock absorber, lessening the stress both on pet and handler, while maintaining control of the pet. Two different configurations are presented, each with its own advantages.

As the pet lunges or pulls, the elastic material stretches, increasing the resistive pressure against the pet, without eliciting a panic response. This allows the pet to “understand” the cause and effect of lunging, without identifying this with the handler.

As the pet lunges, however, the shock of the sudden pull is applied more slowly to the handler, allowing the handler time to adjust to the force, and keep his/her balance. This results in more control of the pet, and less chance of injury due to falling.

The rotating parts allow the leash to be used continuously, without the need for stopping to untangle the leash line.

The device also protects pet who may inadvertently escape the handler. A pet running at full tilt may be injured if the leash catches on an stationary object. The elastic material will soften the stopping motion, and reduce or eliminate the possibility of injury due to a sudden stop.

In the configuration shown in Drawing 1 shows the use of the Lungie with the elastic material at the end where it hooks onto the existing collar or other restrain device which is applied to the creature to be controlled or trained. This ensures that the shock absorbing feature is always available.

In the configuration shown in Drawing 2 shows the use of the Lungie with the elastic material at the end where the handler loop is located, which gives the option of grasping the leash at a point beyond the elastic material and imposing a direct application of control when necessary, without the shock absorption.

My original intellectual contributions are the configurations processes and methods that are needed to accomplish the counter-force reductions, and overcome power losses due to pressure, frictional, and other forces, as well as the drawings.

The components listed in the drawing page are necessary to, and comprise the unique elements of, the complete system. The components listed in this application constitute the full system as designed for use and are set forth as an example of the use of the process and method, and are not exhaustive or all inclusive.

### Additional Applications

In addition to personal pet applications, we intend to develop the following applications:

Medium Sized Pets, or Exotic Animals
With manufacture and specification the device can be used as a restraint, or control, for larger animals, including exotic animals, such as lions.

Human Application
With further development, the device can be suitable for use in preventing children from wandering off, while giving them a sense of freedom. Parents can be sure their child is with them, even if they cannot carry the child in crowded areas, without the danger of injury presented by current restrain systems which do not incorporate a cushioning factor.

Pet Grooming Services
With further development, the device can be widely used in pet grooming services to provide a “third hand” to restrain unruly pets, while maintaining safety for the pet.

This filing refers to Provisional Patent No. 61/630,319 filed by Scott Clair Pockrandt, issued on Dec. 9, 2011.

1. I have developed a process and method which uses an elastic substance, coupled with rotating parts, to reduce shock from movement of a pet, exotic creature, child or other creature, thereby reducing or eliminating the possibility of injury to the handler and/or pet, exotic creature, child or other creature due to such movement.

2. I have developed a process and method which uses an elastic substance, coupled with rotating parts which will reduce or eliminate harm to pet, exotic creature, child or other creature whose restraining device and/or leash suddenly becomes tangled, snagged or otherwise stops the pet's movement immediately.

3. I have developed a process and method which uses an elastic substance, coupled with rotating parts, to assist in training pet, exotic creature, or other creature in a more morally responsible manner, while still maintaining control over the creature being trained.
Current leashes and collars operate to restrain and/or control the movements of pets, and their behavior. Each of the existing designs causes vibration, movement and sudden changes in direction to be transmitted both from the handler and the pet to the other in sharp and sudden manner.
My device, as described in the accompanying drawings and explanatory materials, reduces the impact and sudden nature of the vibration, movements and changes in direction, without interfering with the control of the pet. This increases effective control of the pet, while protecting the handler from potentially severe injury, including hyper extension of elbows, and dislocation of shoulders.
The application of this process and method, is not a “common usage” or “obvious” use or combination of the materials involved. There is no other system which takes advantage of the inherent pressures within a system in the way presented here.
With sizes made properly for individual pets and/or their weights, the device is appropriate for a wide range of pets, including dogs, cats and larger and more exotic creatures.
